(19) United States
(12) Patent Application Publication
(10) Pub. No.: US 2010/0159421 A1
(43) Pub. Date: Jun. 24, 2010

(54) Dental Implant Component Placement and Fixation Device

(76) Inventors: Sreenivas Koka, Rochester, MN (US); Thomas J. Salinas, Rochester, MN (US)

Correspondence Address: QUARLES & BRADY LLP, 411 E. WISCONSIN AVENUE, SUITE 2040, MILWAUKEE, WI, 53202-4497, US

(21) Appl. No.: 12/641,759

(22) Filed: Dec. 18, 2009

Related U.S. Application Data
(60) Provisional application No. 61/138,728, filed on Dec. 18, 2008.

(51) Int. Cl. A61C 8/00

(52) U.S. Cl. 433/201.1

(57) ABSTRACT

A device for placing and affixing a dental component to a dental implant permits the precise placement of the dental component (such as an abutment or crown) onto a dental implant in a manner that also provides for a retaining screw to be tightened without having to release the component in any way and hence risk its movement to a non-desired position. In one form, the device comprises a holder including a base having an access opening extending from a first end to a second opposite end of the base, the access opening having an inner surface defining a cylindrical first section and a frustoconical second section, the second section being dimensioned to engage the dental component in an interference fit, the inner surface of the second section terminating in a continuous perimeter at the second end of the base. In another form, the device comprises a holder including a base having an access opening extending from a first end to a second opposite end of the base, the access opening having an inner surface defining a first section and a second section, wherein the inner surface at the second section includes one or more inwardly extending ribs.

### CROSS-REFERENCES TO RELATED APPLICATIONS

This application claims priority based on U.S. Provisional Application No. 61/138,728 filed Dec. 18, 2008.

### STATEMENT REGARDING FEDERALLY SPONSORED RESEARCH

Not Applicable.

### BACKGROUND OF THE INVENTION

1. Field of the Invention

The invention relates to methods and devices for placing and affixing a dental component to a dental implant.

2. Description of the Related Art

An implant supported dental restoration generally includes a dental implant, a retaining screw, and a dental component. The dental implant is surgically embedded into the jawbone (mandible or maxilla), and a healing period follows in which bone growth around the dental implant (i.e., osseointegration) occurs. The implant is then exposed, and a dental component with a throughhole is placed over the implant. The dental component is secured to the implant by inserting the retaining screw into the throughhole of the dental component and threading the screw into engagement with an internally threaded bore in the implant.

In one example restoration, the dental component is an abutment, and a separate dental prosthesis is cemented to the abutment after the abutment is secured to the implant. In another example restoration, the dental component is a dental prosthesis that is secured directly to the dental implant without any intervening abutment.

The placement of dental components accurately onto dental implants and the tightening of retaining screws is technically challenging because the dental component may move during tightening of the retaining screw. If a dental component is not precisely positioned, damage to the implant or the implant components may occur as well as damage to biological structures in the mouth.

U.S. Pat. Nos. 5,322,443, 5,437,550, 5,462,436 and 5,692,904 describe methods and means for affixing a component to a dental implant.

However, there still exists a need for improved methods and devices for placing and affixing a dental component to a dental implant.

### SUMMARY OF THE INVENTION

The present invention addresses the foregoing need by providing a placement/fixation device that permits the precise placement of dental implant components (mainly abutments and crowns) onto dental implants in a manner that also provides for retaining screws to be tightened without having to release the dental component in any way and hence risk movement of the dental component to a non-desired position. The invention merges two aspects of clinical practice: (1) placement of a dental component, and (2) tightening of its associated retaining screw that holds the dental component in place. The invention permits customization for all shapes and sizes of dental components, whether they be pre-machined or customized components. An access opening created in the top of a holder permits an appropriate torque driver to be used to tighten the retaining screw without having to let go of the dental component.

In one version, the invention provides a device for placing and affixing a dental component to a dental implant. The device comprises a holder including a base having an access opening extending from a first end to a second opposite end of the base. The access opening has an inner surface defining a cylindrical first section and a frustoconical second section. The second section is dimensioned to engage the dental component in an interference fit when the dental component is inserted in the access opening of the base. The inner surface of the second section terminates in a continuous perimeter at the second end of the base. The holder can further include an arm that extends at an oblique angle outwardly from the outer surface of the base. The arm can include a handle spaced from the outer surface of the base wherein the handle has a transverse cross-sectional area greater than a transverse cross-sectional area of the arm. The holder can further include a second arm that extends outwardly from the outer surface of the base. The second arm can includes a handle spaced from the outer surface of the base wherein the handle has a transverse cross-sectional area greater than a transverse cross-sectional area of the second arm. Optionally, a viscous material can be disposed on the inner surface at the second section. The viscous material is suitable for immobilizing the dental component in the access opening.

In another version, the invention provides a device for placing and affixing a dental component to a dental implant. The device comprises a holder including a base having an access opening extending from a first end to a second opposite end of the base. The access opening has an inner surface defining a first section and a second section. The inner surface at the second section includes one or more inwardly extending ribs. The second section can be frustoconical. The rib(s) of the second section are dimensioned to engage the dental component in an interference fit when the dental component is inserted in the access opening of the base. The inner surface of the second section terminates in a continuous perimeter at the second end of the base. The holder can further include an arm that extends at an oblique angle outwardly from the outer surface of the base. The arm can include a handle spaced from the outer surface of the base wherein the handle has a transverse cross-sectional area greater than a transverse cross-sectional area of the arm. The holder can further include a second arm that extends outwardly from the outer surface of the base. The second arm can includes a handle spaced from the outer surface of the base wherein the handle has a transverse cross-sectional area greater than a transverse cross-sectional area of the second arm. Optionally, a viscous material can be disposed on the inner surface at the second section. The viscous material is suitable for immobilizing the dental component in the access opening.

Any version of the device of the invention can be used in a method according to the invention for placing and affixing a dental component to a dental implant. A dental component is press fit into in the second section of the access opening of the holder of the device. A throughhole of the dental component is aligned with a bore of the dental implant, and a fastener is inserted into the throughhole and the bore to affix the dental component to the dental implant. The dental component can have a frustoconical outer surface that engages the inner surface at the second section of the access opening of the holder. The dental component can be a prosthetic tooth that engages the inner surface at the second section of the access opening of the holder. The fastener can be a retaining screw having a head dimensioned to enter the access opening at the first end of the holder. In one version of the method, a driver is passed into the access opening at the first end of the base of the holder, the fastener is threaded into the bore of the dental implant using the driver, and the driver is removed from the access opening at the first end of the base of the holder.

Any version of the device of the invention can be provided in a dental implant kit that can be contained in a sterile package. The kit includes the device of the invention, and a dental component having a frustoconical outer surface that is dimensioned to engage the second section of the access opening of the base of the holder when the dental component is inserted in the access opening of the base. In one form of the kit, the dental component is an abutment. The holder is used to place the dental component on the dental implant and align the throughhole of the dental component with a bore of the dental implant. A fastener is inserted into the throughhole and the bore to affix the dental component to the dental implant. In another form of the kit, the dental component is a prosthetic tooth dimensioned to engage the second section of the access opening of the base of the holder when the prosthetic tooth is inserted in the access opening of the base.

It is an advantage of the invention to provide methods and devices for placing and affixing a dental component to a dental implant wherein the risk of damage to tissue is minimized.

It is another advantage of the invention to provide methods and devices for placing and affixing a dental component to a dental implant wherein the positioning of the dental component and implant are not destroyed during installation.

It is yet another advantage of the invention to provide methods and devices for placing and affixing a dental component to a dental implant wherein the positioning of the dental component and implant does not have to be confirmed using X-rays.

These and other features, aspects, and advantages of the present invention will become better understood upon consideration of the following detailed description, drawings, and appended claims.

### BRIEF DESCRIPTION OF THE DRAWINGS

FIG. 1 is a front view of a dental component holder according to the invention.

FIG. 2 is a top view of the dental component holder of FIG. 1.

FIG. 3 is a cross-sectional view of the dental component holder of FIG. 2 taken along line 3-3 of FIG. 2.

FIG. 4 is an exploded vertical cross-sectional view of the parts of one example embodiment of a device for placing and affixing a dental component to a dental implant according to the invention.

FIG. 5 is a vertical cross-sectional view of the dental component holder of the invention locating an abutment over a dental implant.

FIG. 6 is a vertical cross-sectional view of a retaining screw being inserted in the access opening of the dental component holder after the abutment is placed in contact with the dental implant.

FIG. 7 is a vertical cross-sectional view of the dental component holder being removed from the abutment after the abutment is affixed to the dental implant.

FIG. 8 is a vertical cross-sectional view of the abutment affixed to the dental implant.

FIG. 9 is a vertical cross-sectional view of a dental prosthesis (artificial tooth) affixed to the abutment.

FIG. 10 is a vertical cross-sectional view of a retaining screw being inserted in the access opening of a dental component (dental prosthesis) after the dental component is placed in contact with the dental implant in accordance with another example embodiment of a device for placing and affixing a dental component to a dental implant.

FIG. 11 is a vertical cross-sectional view similar to FIG. 10 of the dental component holder being removed from the dental component after the dental component is affixed to the dental implant.

Like reference numerals will be used to refer to like parts from Figure to Figure in the following description of the drawings.

### DETAILED DESCRIPTION OF THE INVENTION

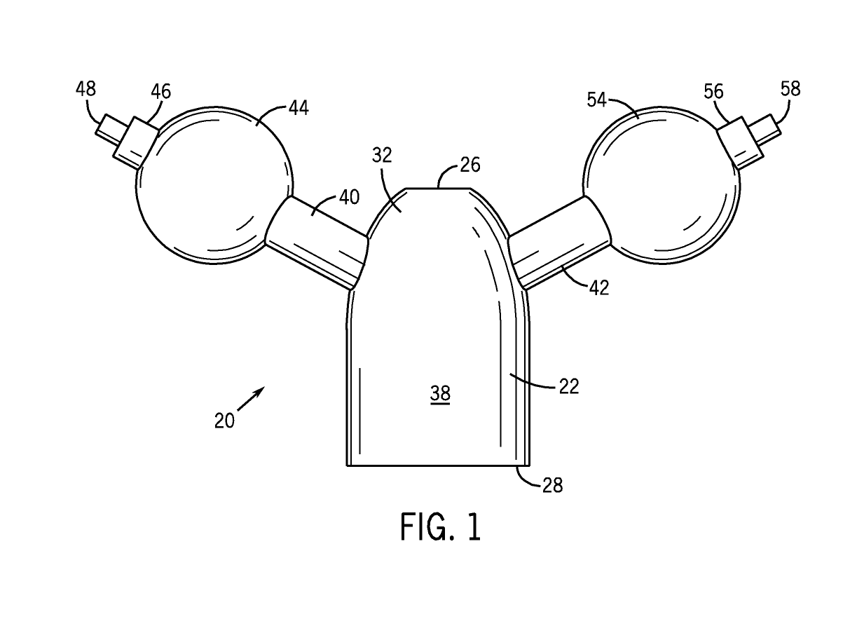

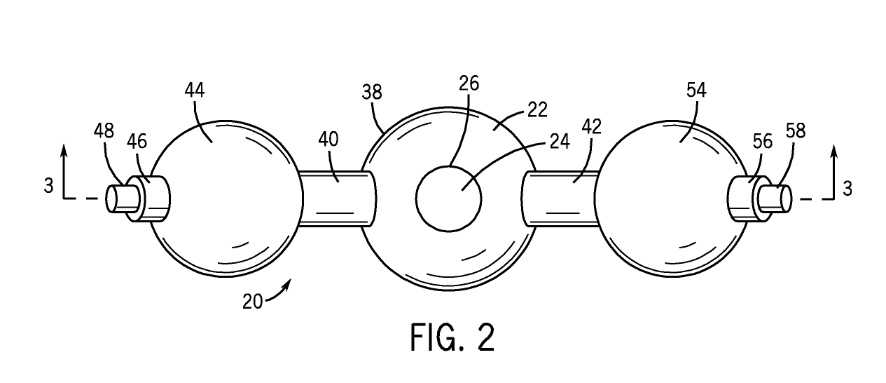

Looking first at FIGS. 1-3, there is shown a dental component holder 20 that can be used in a method and device for placing and affixing a dental component to a dental implant in accordance with the invention. The holder 20 may be fabricated from a metallic, ceramic, polymeric, or composite material. Preferably, the holder 20 is fabricated from a polymeric material such as a polyolefin, or an acrylic material such as polymethylmethacrylate. The polymeric material may be transparent, translucent or opaque. The holder 20 can be fabricated from a material that can be autoclaved.

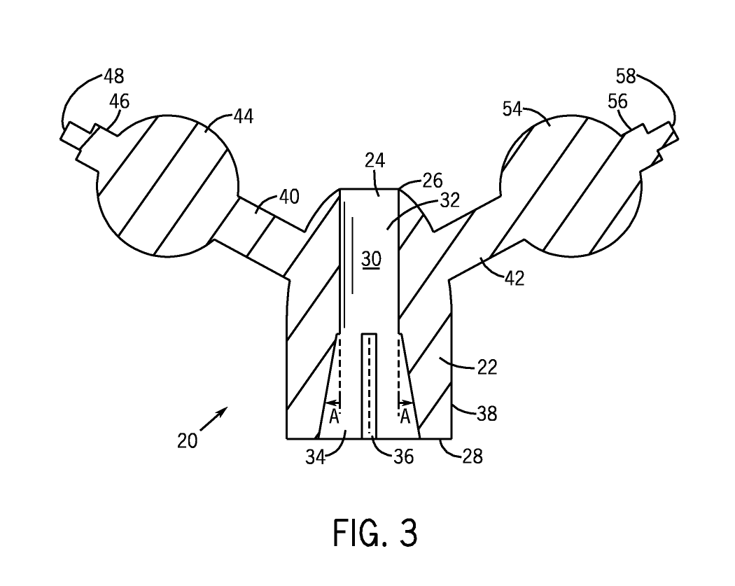

The holder 20 includes a base 22 having an access opening 24 that extends from a top end 26 to a generally flat bottom end 28 of the base 22. The access opening 24 has an inner surface 30 defining a cylindrical upper section 32 and a frustoconical lower section 34. An angle A is formed where the upper section 32 and the lower section 34 of the access opening 24 meet as shown in FIG. 3. The angle A can be 1-20 degrees, preferably 3-15 degrees, and most preferably 5-10 degrees. The lower section 34 includes one or more ribs 36 that extend inward from the inner surface 30 of the access opening 24. The outer surface 38 of the base 22 has a somewhat domed shape. The flat bottom end 28 of the base 22 in the embodiment shown has a circular outer perimeter. The outside diameter of the flat bottom end 28 of the base 22 can be selected such that the flat bottom end 28 of the base 22 can be positioned in a space created between teeth. For example, the outside diameter of the flat bottom end 28 of the base 22 can be selected to be less than the distance between a 1st molar and a 3rd molar, or the distance between a 1st bicuspid and a lateral incisor.

The holder 20 includes a first generally cylindrical arm 40 and a second generally cylindrical arm 42 that extend outwardly from the outer surface 38 of the base 22. The first arm 40 and the second arm 42 incline upwardly as they extend outwardly from the outer surface 38 of the base 22. The first arm 40 terminates in a generally spherical handle 44 having a first disc-shaped protrusion 46 with a second disc-shaped protrusion 48. The second arm 42 terminates in a generally spherical handle 54 having a first disc-shaped protrusion 56 with a second disc-shaped protrusion 58.

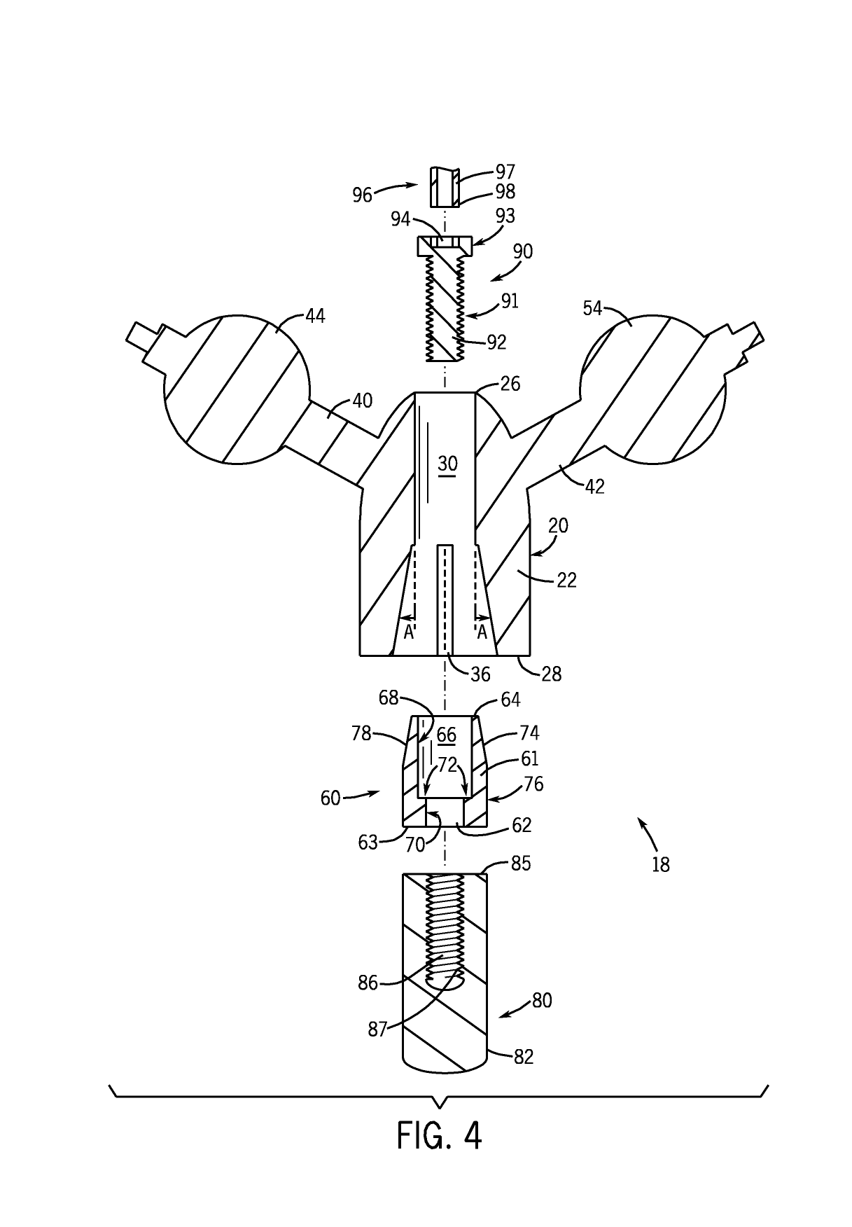

Referring now to FIG. 4, one example embodiment of a device 18 for placing and affixing a dental component to a dental implant in accordance with the invention includes an abutment 60. The abutment 60 may be fabricated from a metallic material (such as a titanium alloy or gold), a ceramic material (e.g., zirconia), a polymeric material, or a composite material. The abutment 60 has a hollow wall 61 defining a throughhole 62 that extends from a bottom end 63 to a top end 64 of the abutment 60. The throughhole 62 has an inner surface 66 defining a cylindrical upper section 68 and a cylindrical lower section 70. A shoulder 72 is formed where the upper section 68 and the lower section 70 (which is of lesser inside diameter) of the throughhole 62 meet as shown in FIG. 4. The outer surface 74 of the abutment 60 has a cylindrical lower section 76 and a frustoconical upper section 78. Other shapes for the abutment 60 are also possible. It should be appreciated that the terms “bottom” and “top” have been used for convenience and do not imply that the abutment 60 must be arranged as shown in FIG. 4. When used with an implant in the mandible, the abutment 60 will be oriented as shown in FIG. 4. However, when used with an implant in the maxilla, the abutment 60 will be inverted 180 degrees in relation to the abutment 60 as shown in FIG. 4.

Still referring to FIG. 4, one example embodiment of a device for placing and affixing a dental component to a dental implant in accordance with the invention includes a dental implant 80. The implant 80 may be fabricated from a metallic material (such as a titanium alloy or gold), a ceramic material (e.g., zirconia), a polymeric material, or a composite material.

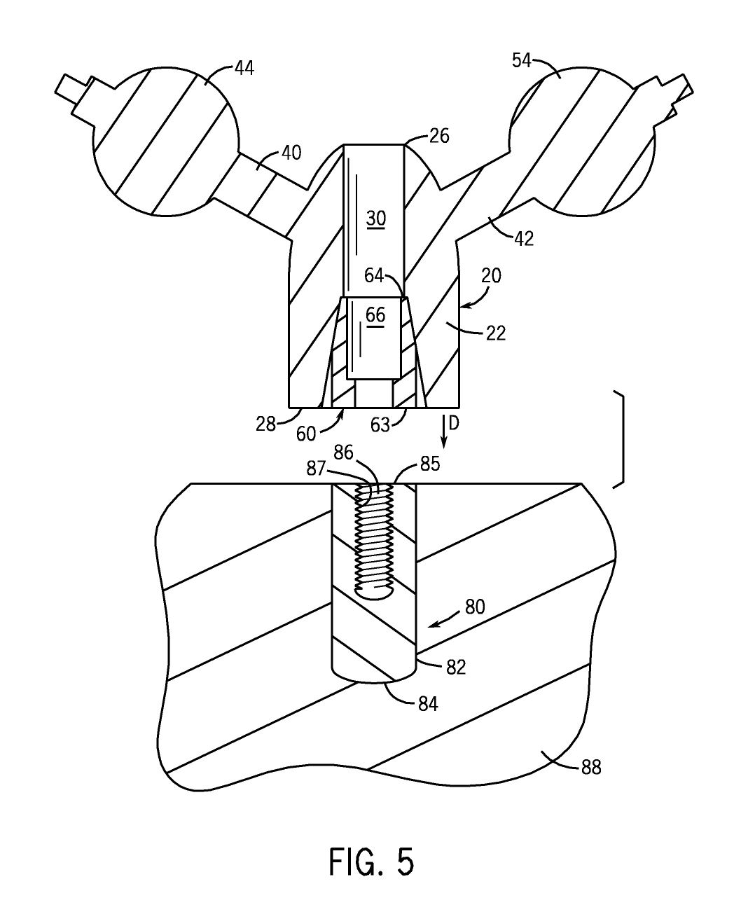

The implant 80 has a cylindrical outer surface 82 that terminates in a bottom end 84 and a top end 85. The implant 80 includes a bore 86 having internal threads 87. The bore 86 extends downward from the top end 85 of the implant 80. In FIG. 5, the implant 80 is shown installed in the mandible 88 of a patient. Surgical techniques for embedding the implant 80 into the mandible 88 (or maxilla) are known in the dental field and therefore will not be described further. It should be appreciated that the terms “bottom” and “top” have been used for convenience and do not imply that the implant 80 must be arranged as shown in FIGS. 4 and 5. When used in the mandible, the implant 80 will be oriented as shown in FIGS. 4 and 5. However, when used in the maxilla, the implant 80 will be inverted 180 degrees in relation to the implant 80 as shown in FIGS. 4 and 5.

Referring to FIG. 4, one example embodiment of a device for placing and affixing a dental component to a dental implant in accordance with the invention includes a retaining screw 90. The retaining screw 90 may be fabricated from a metallic, ceramic, polymeric, or composite material. Preferably, the retaining screw 90 is fabricated from a biocompatible metallic material such as a titanium alloy or stainless steel. The retaining screw 90 has a shaft 91 with threads 92 and a head 93 with a hexagonal socket 94. Other screw heads such as (without limitation) slotted heads, Phillips heads, and hex heads may also be used.

Referring to FIG. 4, one example embodiment of a device for placing and affixing a dental component to a dental implant in accordance with the invention includes a screwdriver 96 having a shaft 97 with a hexagonal tip 98. The tip is selected based on the configuration of the head 93 of the retaining screw 90 as is known in the art. Other tips may be used such as a flat head or Phillips head. The shaft 97 and tip 98 may be rotated manually, or by a motor.

Having described the parts for one example embodiment of a device 18 for placing and affixing a dental component to a dental implant in accordance with the invention, use of the device 18 can be explained. Looking at FIG. 5, the implant 80 is shown installed in the mandible 88 of a patient. The dental practitioner inserts the abutment 60 into the holder 20 such that the frustoconical upper section 78 of the outer surface 74 of the abutment 60 frictionally engages the ribs 36 that extend inward from the inner surface 30 of the access opening 24 of the holder 20. Alternatively, in versions of the holder 20 that do not include ribs 36, the dental practitioner inserts the abutment 60 into the holder 20 such that the frustoconical upper section 78 of the outer surface 74 of the abutment 60 frictionally engages the frustoconical lower section 34 of the inner surface 30 of the access opening 24 of the holder 20. Thus, the abutment 60 is held in the access opening 24 of the holder 20 by a press fit.

The ribs 36 that extend inward from the inner surface 30 of the access opening 24 of the holder 20 can be advantageous in that the engagement of the abutment 60 in the holder 20 can be controlled by providing ribs with engagement surfaces of different widths that varying the engagement forces.

The angle A of the frustoconical lower section 34 is advantageous as different diameter abutments can be engaged by the inner surface of the frustoconical lower section 34. In other words, the angle A of the frustoconical lower section 34 creates an inner surface of diminishing diameter from the bottom end 28 toward the top end 26 of the base 22 such that larger diameter abutments may engage the inner surface of the frustoconical lower section 34 at lower regions of the inner surface of the frustoconical lower section 34 whereas smaller diameter abutments may engage the inner surface of the frustoconical lower section 34 at more upper regions of the inner surface of the frustoconical lower section 34.

In yet another alternative, a viscous material such as a curable silicone (e.g., polyvinyl siloxane) is placed on the frustoconical lower section 34 of the inner surface 30 of the access opening 24 of the holder 20 and then the dental practitioner inserts the abutment 60 into the holder 20 such that the curable material immobilizes the abutment 60 in the holder 20.

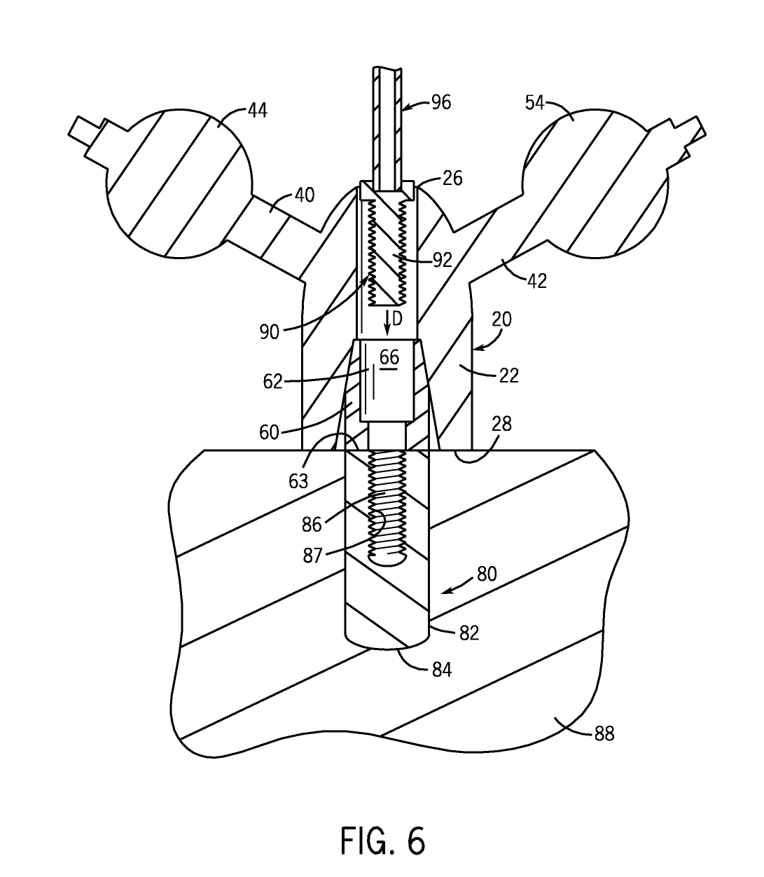

The dental practitioner then grasps any of the arms 40, 42 or handles 44, 54 of the holder 20 with a dental instrument (or by hand) and locates the abutment 60 over the implant 80 such that the throughhole 62 of the abutment 60 is aligned with the bore 86 of the implant 80 as shown in FIG. 5. The holder 20 is then moved in direction D shown in FIG. 5 such that the bottom end 63 of the abutment 60 and the top end 85 of the implant 80 are in contact as shown in FIG. 6. Optionally, the bottom end 63 of the abutment 60 and the top end 85 of the implant 80 may include mating structures (such as a protrusion in the abutment 60 and a depression in the implant 80) that assist in alignment of the bottom end 63 of the abutment 60 and the top end 85 of the implant 80.

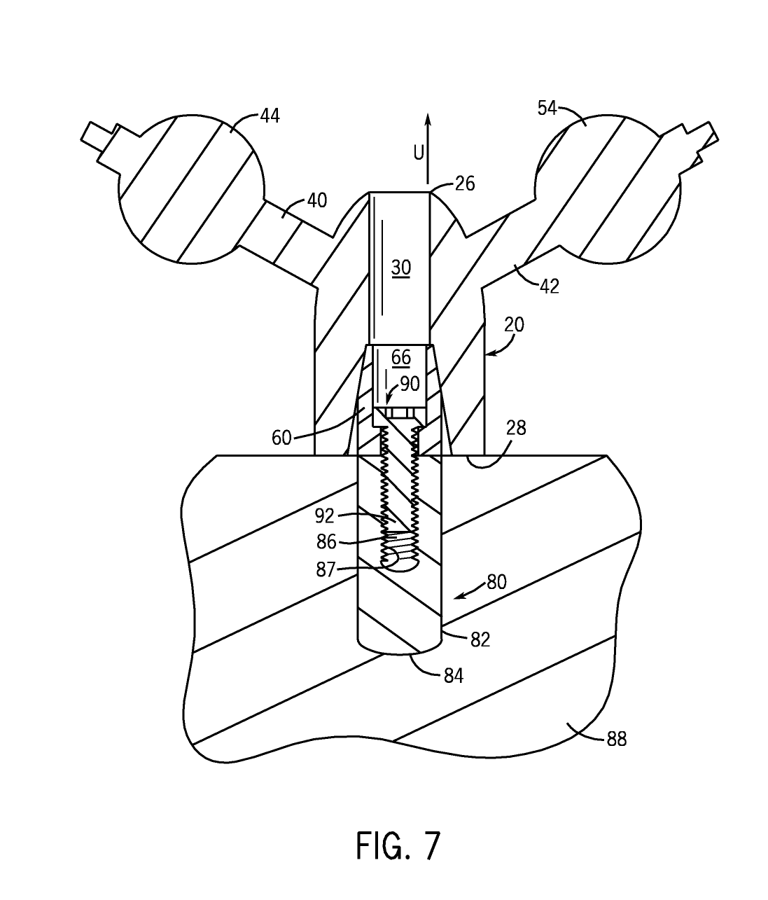

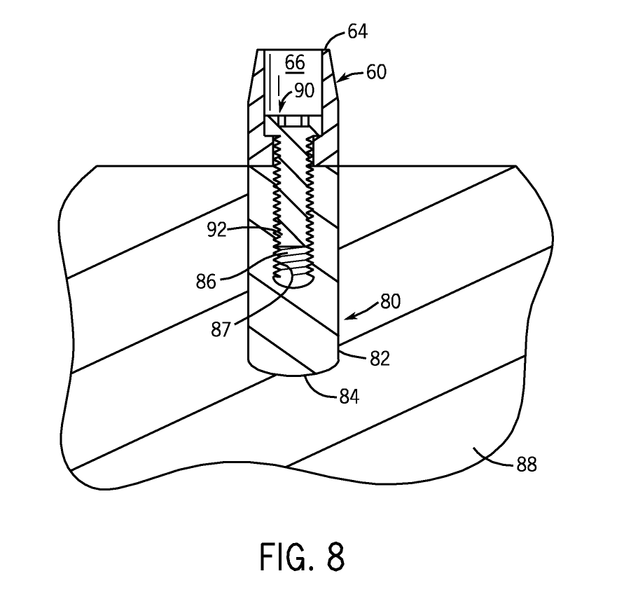

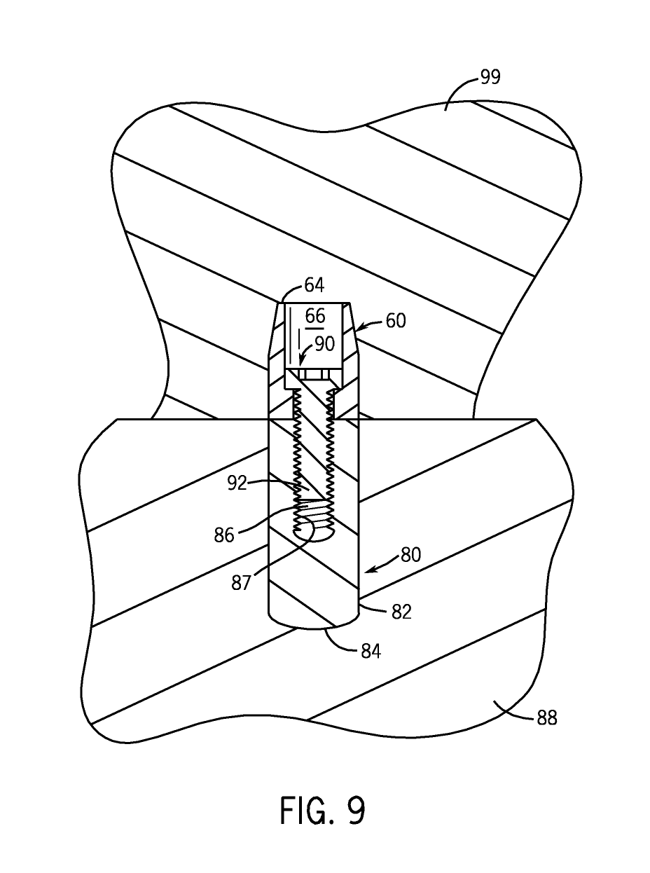

Next, as shown in FIG. 6, the hexagonal tip 98 of the screwdriver 96 is inserted in the hexagonal socket 94 of the retaining screw 90 and the retaining screw 90 is moved downward in direction D through the throughhole 62 of the abutment 60 and into the bore 86 of the implant 80. The retaining screw 90 is threaded into engagement with the internal threads 87 of the bore 86 in the implant 80. This secures the abutment 60 to the implant 80 as shown in FIG. 7. Looking at FIG. 7, the screwdriver 96 and then the holder 20 are moved upward in direction U thereby leaving the assembled abutment 60, retaining screw 90, and implant 80 as shown in FIG. 8. A dental prosthesis such as artificial tooth 99 may then be cemented to the abutment 60 as shown in FIG. 9.

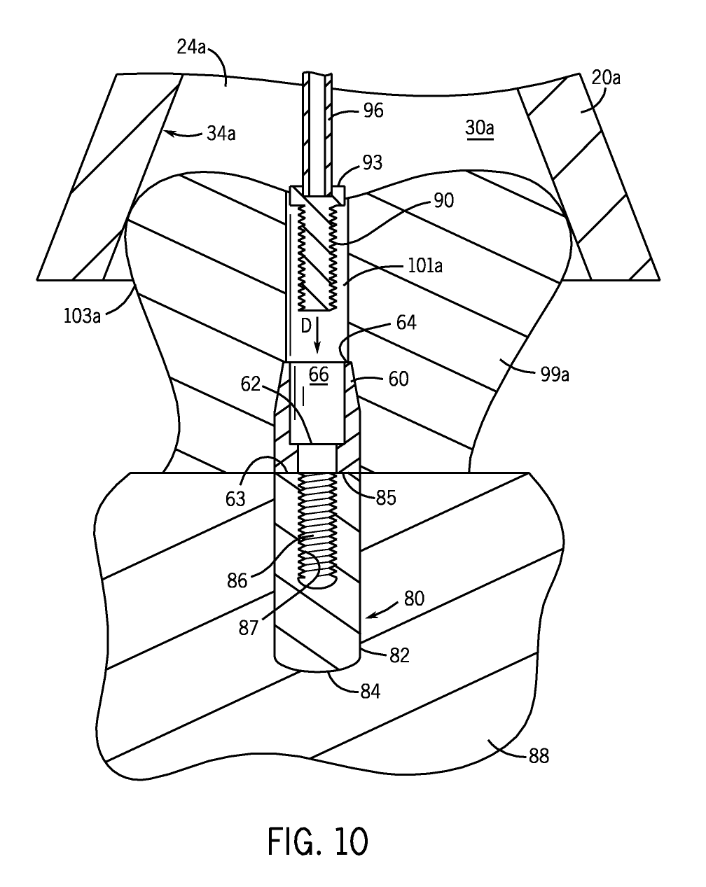

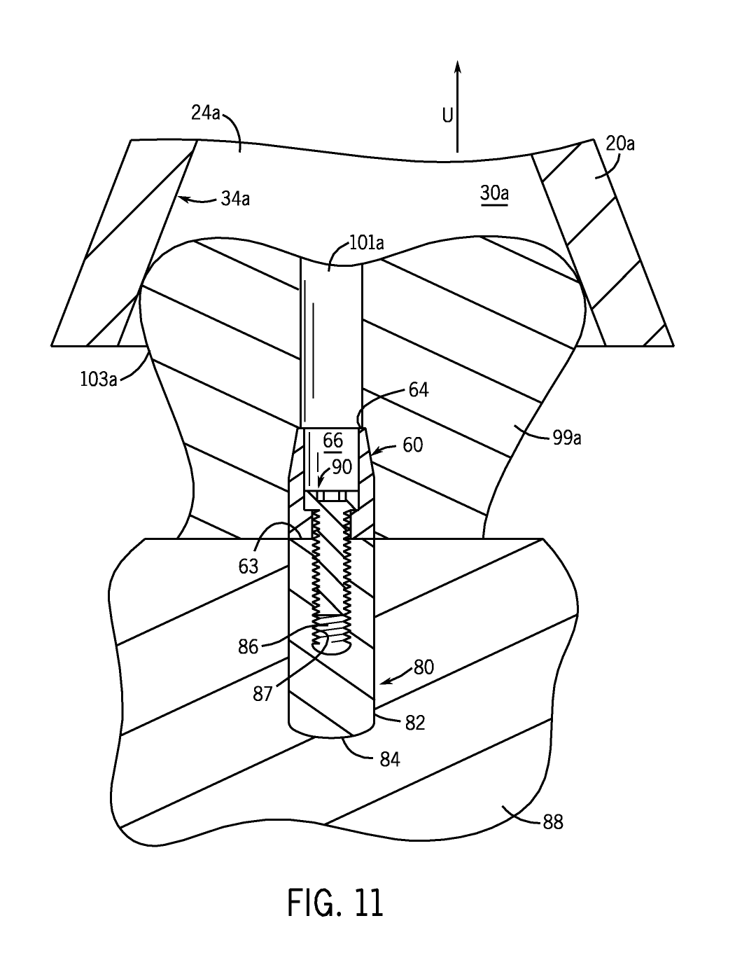

Turning now to FIGS. 10 and 11, another example embodiment of a device for placing and affixing a dental component to a dental implant is shown. In this device, the abutment 60 is manufactured as part of a dental prosthesis 99a. The implant 80 is shown installed in the mandible 88 of a patient. The dental practitioner inserts the dental prosthesis 99a into the holder 20a such that the outer surface 103a of the dental prosthesis 99a frictionally engages the frustoconical lower section 34a of the inner surface 30a of the access opening 24a of the holder 20a. Thus, the dental prosthesis 99a is held in the access opening 24a of the holder 20a.

The dental practitioner then grasps any of the arms or handles of the holder 20a with a dental instrument (or by hand) and locates the dental prosthesis 99a over the implant 80 such that the throughhole 62 of the abutment 60 is aligned with the bore 86 of the implant 80 as shown in FIG. 10. The holder 20a is then moved such that the bottom end 63 of the abutment 60 and the top end 85 of the implant 80 are in contact as shown in FIG. 10.

Next, as shown in FIG. 10, the hexagonal tip 98 of the screwdriver 96 is inserted in the hexagonal socket 94 of the retaining screw 90 and the retaining screw 90 is moved downward in direction D through the vertical opening 101a of the dental prosthesis 99a and through the throughhole 62 of the abutment 60 and into the bore 86 of the implant 80. The retaining screw 90 is threaded into engagement with the internal threads 87 of the bore 86 in the implant 80. This secures the abutment 60 of the dental prosthesis 99a to the implant 80 as shown in FIG. 11. Looking at FIG. 11, the screwdriver and then the holder 20a are moved upward in direction U thereby leaving the assembled dental prosthesis 99a, retaining screw 90, and implant 80 as shown in FIG. 11. The opening 101a of the dental prosthesis 99a may then be filled with a curable restorative material such as a paste composite and cured to complete the restoration.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

### INDUSTRIAL APPLICABILITY

The invention provides methods and devices for placing and affixing a dental component to a dental implant.

What is claimed is:

1. A device for placing and affixing a dental component to a dental implant, the device comprising:
a holder including a base having an access opening extending from a first end to a second opposite end of the base, the access opening having an inner surface defining a cylindrical first section and a frustoconical second section, the second section being dimensioned to engage the dental component in an interference fit, the inner surface of the second section terminating in a continuous perimeter at the second end of the base.

2. The device of claim 1 wherein:
the holder further includes an arm that extends outwardly from an outer surface of the base.

3. The device of claim 2 wherein:
the arm extends at an oblique angle outwardly from the outer surface of the base.

4. The device of claim 2 wherein:
the arm includes a handle spaced from the outer surface of the base, the handle having a transverse cross-sectional area greater than a transverse cross-sectional area of the arm.

5. The device of claim 2 wherein:
the holder further includes a second arm that extends outwardly from the outer surface of the base.

6. The device of claim 1 further comprising:
a viscous material disposed on the inner surface at the second section, the viscous material suitable for immobilizing the dental component in the access opening.

7. A method for placing and affixing a dental component to a dental implant, the method comprising:
(a) providing the device of claim 1;
(b) press fitting the dental component in the second section of the access opening of the holder; and
(c) aligning a throughhole of the dental component with a bore of the dental implant; and
(d) inserting a fastener into the throughhole and the bore to affix the dental component to the dental implant.

8. The method of claim 7 wherein:
the dental component has a frustoconical outer surface that engages the inner surface at the second section of the access opening of the holder.

9. The method of claim 7 wherein:
the dental component is a prosthetic tooth that engages the inner surface at the second section of the access opening of the holder.

10. The method of claim 7 wherein:
the fastener is a retaining screw having a head dimensioned to enter the access opening at the first end of the holder.

11. The method of claim 10 wherein:
step (d) comprises passing a driver into the access opening at the first end of the base of the holder, threading the fastener into the bore of the dental implant using the driver, and removing the driver from the access opening at the first end of the base of the holder.

12. A dental implant kit comprising:
the device of claim 1; and
a dental component having a frustoconical outer surface dimensioned to engage the second section of the access opening of the base of the holder when the dental component is inserted in the access opening of the base.

13. A dental implant kit comprising:
the device of claim 1; and
a prosthetic tooth dimensioned to engage the second section of the access opening of the base of the holder when the prosthetic tooth is inserted in the access opening of the base.

14. A device for placing and affixing a dental component to a dental implant, the device comprising:
a holder including a base having an access opening extending from a first end to a second opposite end of the base, the access opening having an inner surface defining a first section and a second section, wherein the inner surface at the second section includes one or more inwardly extending ribs.

15. The device of claim 14 wherein:
the second section is frustoconical.

16. The device of claim 14 wherein:
the holder further includes an arm that extends outwardly from an outer surface of the base.

17. The device of claim 16 wherein:
the arm includes a handle spaced from the outer surface of the base, the handle having a transverse cross-sectional area greater than a transverse cross-sectional area of the arm.

18. A method for placing and affixing a dental component to a dental implant, the method comprising:
(a) providing the device of claim 14;
(b) press fitting the dental component in the second section of the access opening of the holder; and
(c) aligning a throughhole of the dental component with a bore of the dental implant; and
(d) inserting a fastener into the throughhole and the bore to affix the dental component to the dental implant.

19. A dental implant kit comprising:
the device of claim 14; and
a dental component having a frustoconical outer surface dimensioned to engage each rib of the second section of the access opening of the base of the holder when the dental component is inserted in the access opening of the base.

20. A dental implant kit comprising:
the device of claim 14; and
a prosthetic tooth dimensioned to engage each rib of the second section of the access opening of the base of the holder when the prosthetic tooth is inserted in the access opening of the base.
